(19) United States
(12) Patent Application Publication
(10) Pub. No.: US 2016/0086139 A1
(43) Pub. Date: Mar. 24, 2016

(54) Method for Scheduling and Managing Appointments Between Multiple Unaffiliated Parties

(71) Applicant: Erica Lee White, Wethersfield, CT (US)

(72) Inventor: Erica Lee White, Wethersfield, CT (US)

(21) Appl. No.: 14/863,713

(22) Filed: Sep. 24, 2015

Related U.S. Application Data
(60) Provisional application No. 62/071,406, filed on Sep. 24, 2014.

(51) Int. Cl. G06Q 10/10

(52) U.S. Cl. CPC G06Q 10/1095

(57) ABSTRACT

A method for scheduling and maintaining appointments between multiple parties is provided, wherein the method is implementing via a processing device. The method includes creating an online account for a first user and setting up a first user calendar wherein the first user calendar is configurable to include first user information and wherein the first user information include a date and time that first user is available for a meeting, creating an online account for a second user, wherein the second user is configured to be able view the first user calendar and the first user information and allowing the second user to access the first user calendar to modify the first user information to set up a meeting appointment by reserving the date and time for a meeting.

### CROSS-REFERENCE TO RELATED APPLICATIONS

The present application is related to and the claims benefit of the filing dates of U.S. Provisional Patent Application Ser. No. 62/071,406, filed Sep. 24, 2014, the contents of which are incorporated herein by reference in its entirety.

### BACKGROUND OF THE INVENTION

The majority of postsecondary and admission representatives are using e-mail, phone calls, and the postal service to schedule visits with high schools and perspective students. These methods are time consuming often resulting in multiple emails or phone calls back and forth between the parties in order to coordinate a common time to meet. In addition, representatives often have to schedule appointments that are geographically far apart or that consist of time gaps in between appointments due to the inability to identify appointment availability across multiple high schools. Unfortunately, this gap of time in between meetings and the time spent traveling reduces the number of high school visits the postsecondary representative is able to schedule within a day thereby decreasing postsecondary and mission outreach and marketing effectiveness.

Currently, there are no platforms available to schedule and manage appointments between multiple unaffiliated parties, such as a postsecondary institution and a high school, which address all of the issue specific to the scheduling. Although generic online scheduling software exists, it was created and configured for general use and thus is not directed for communication between postsecondary institutions and high schools, where there are unique and complex set of problems and scheduling requirements. This generic software is deficient in that it does not provide a common platform to address current issues, therefore requiring the postsecondary representative to maintain multiple software accounts and be familiar with multiple types of software programs. Other available software, that provides a listing of the policies for each school, does not adequately solve the problem as the representative is still required to call, e-mail or use the postal service to schedule an appointment. Lastly, the software also does not allow the postsecondary representative to view appointment availability across multiple on affiliated high schools.

### SUMMARY OF THE INVENTION

By using one centralized appointment software program, the process of scheduling meetings can be streamlined, eliminating the need for repetitious phone calls/emails/mailings and multiple software accounts. Through the use of this software, high schools may customize their online schedules based on their own visiting policy and unique high school schedule. Postsecondary representatives may plan visits by distance or availability and view high school information. Representatives may view multiple appointment options across multiple unaffiliated high schools. In addition, high schools may advertise college fairs and postsecondary representatives may register online for the college fairs. Both parties can view their upcoming schedule and send individual or mass emails to previous or future appointments. The postsecondary admission directors may view their employee's schedule and send individual or mass emails to the high school contacts.

A method for scheduling and maintaining appointments between multiple parties is provided, wherein the method is implemented via a processing device. The method includes creating an online account for a first user and setting up a first user calendar wherein the first user calendar is configurable to include first user information and wherein the first user information include a date and time that first user is available for a meeting, creating an online account for a second user, wherein the second user is configured to be able to view the first user calendar and the first user information and allowing the second user to access the first user calendar to modify the first user information to set up a meeting appointment by reserving the date and time for a first meeting.

### BRIEF DESCRIPTION OF THE DRAWINGS

The foregoing and other features and advantages of the present invention will be more fully understood from the following detailed description of illustrative embodiments, taken in conjunction with the accompanying drawings in which like elements are numbered alike:

FIG. 1 is a schematic block diagram illustrating relationships between users, in accordance with one embodiment of the invention;

FIG. 2 illustrates a high school account detail form, in accordance with one embodiment of the invention;

FIG. 3 illustrates a high school calendar setup form, in accordance with one embodiment of the invention;

FIG. 4 illustrates a calendar display, in accordance with one embodiment of the invention;

FIG. 5 illustrates a listing of the representative connections, in accordance with one embodiment of the invention;

FIG. 6 illustrates a form for high school users to approve and communicate with representatives for a college fair, in accordance with one embodiment of the invention;

FIG. 7 illustrates a form for a post-secondary user to setup their account, in accordance with one embodiment of the invention;

FIG. 8 illustrates a vendor search form to find high schools, in accordance with one embodiment of the invention;

FIG. 9 illustrates a form that uses a calendar to allow a post-secondary user to book an available appointment, in accordance with one embodiment of the invention;

FIG. 10 illustrates a post-secondary user's confirmation form to create bookings, in accordance with one embodiment of the invention;

FIG. 11 illustrates a post-secondary user's appointments displayed in a calendar format, in accordance with one embodiment of the invention;

FIG. 12 illustrates a vendor search form to find college fairs and submit a request for a booking, in accordance with one embodiment of the invention;

FIG. 13 illustrates a listing of a post-secondary representative's high school contacts, in accordance with one embodiment of the invention;

FIG. 14 illustrates a view for a post-secondary director user to see the appointments of the representatives, in accordance with one embodiment of the invention;

FIG. 15 illustrates a form for a post-secondary director user to view a consolidated list of all associated representative's contacts and initiate an email to those contacts, in accordance with one embodiment of the invention;

FIG. 16 illustrates a flow block diagram illustrating one method of how a post-secondary user may leverage a search function to create a booking, in accordance with another embodiment of the invention;

FIG. 17 illustrates a flow block diagram illustrating how a post-secondary user may leverage an auto-suggest function to create a multiple booking schedule, in accordance with still yet another embodiment of the invention;

FIG. 18 illustrates a flow block diagram of how a high school user may set up an account and create both individual and college fair appointments, in accordance with still yet another embodiment of the invention;

FIG. 19 illustrates a flow block diagram of how a post-secondary representative may create an account and book appointments for individual and college fair appointments, in accordance with still yet another embodiment of the invention;

FIG. 20 is a flow block diagram illustrating one method a high school user may use to set up the options for their calendar, in accordance with still yet another embodiment of the invention;

FIG. 21 illustrates a user interface form which a post-secondary representative may use to select available appointments from a listing of high schools, in accordance with still yet another embodiment of the invention.

### DETAILED DESCRIPTION OF THE INVENTION

As discussed briefly hereinabove, the booking of high school visits among post-secondary admission representatives has traditionally been handled on a school by school basis via email or phone. The reasons for this are two-fold. Each high school has a unique schedule, visit policy, and varying availability. Each post-secondary admission representative needs to schedule appointments based on recruitment goals and are within close proximately to one another, allow for the maximum amount of visits per day, and permits minimal time gaps between appointments. However, telephone and email based bookings are time consuming and inconvenient, often resulting in the need for multiple emails or phone calls in order to speak to the correct high school contact and to coordinate appointment times. Some high schools are using online appointment booking software, however, these programs are not designed to the unique needs of the high school schedule and post-secondary representatives struggle to keep track of which scheduling method a specific high school is using. Furthermore, without knowing appointment availability across multiple high schools, post-secondary representatives often have to schedule appointments that are geographically far apart or consist of time gap in between appointments due. The gap of time in between meetings and the time spent traveling reduces the number of high school visits a post-secondary representative is able to schedule within a day, decreasing post-secondary outreach.

With traditional scheduling methods, a post-secondary representative typically needs to search through each high schools website or call or email a high school to determine who they need to contact to schedule an appointment, what the high school visit policy is, as well as what dates and times are available. Accordingly, post-secondary admission representatives are stuck using email, phone calls, and the postal service to schedule high school visits to meet with prospective students. Secondary methods include the use generic scheduling software to schedule appointments. And while some high schools use a general scheduling software, this software was created for mass use and thus not directed for communication between post-secondary institutions and high schools. Accordingly, the existing software does not address or solve the specific problems where there are unique and complex scheduling requirements specific to a high school schedule. Additionally, the existing software also does not allow post-secondary representatives to view appointment availability across multiple unaffiliated high schools at the same time.

The present invention provides a method for connecting post-secondary admission representatives and high schools, providing a centralized marketplace for post-secondary institutions to view and schedule appointments across multiple unaffiliated high schools, wherein the method of the invention may be designed to meet the specific needs of high schools and/or post-secondary institutions. These establishments can customize their online schedules based on their own visiting policy and unique schedules. The present invention allows for the process of scheduling appointment to be streamlined, thereby eliminating the need for multiple phone calls and emails, and/or the need to search for a high school scheduling website. It also allows post-secondary admission representatives to plan their appointments within close proximately to one another, thereby allowing for the maximum amount of visits per day, and permitting minimal time gaps in between appointments.

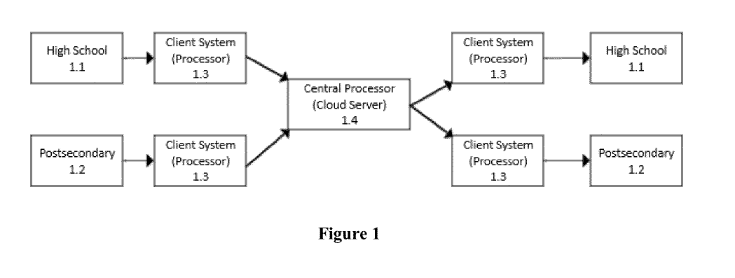

Referring to FIG. 1, a first embodiment of the invention is shown, wherein the high schools (1.1) and post-secondary institutions (1.2) may use a processor (1.3) to input and then later view and/or manipulate data on a software program, such as a cloud server/software program (1.4).

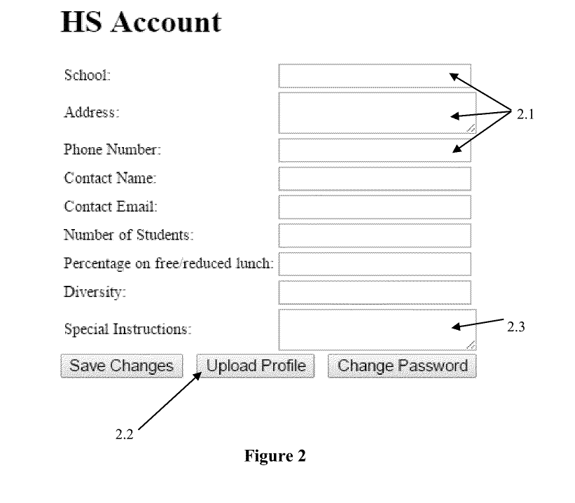

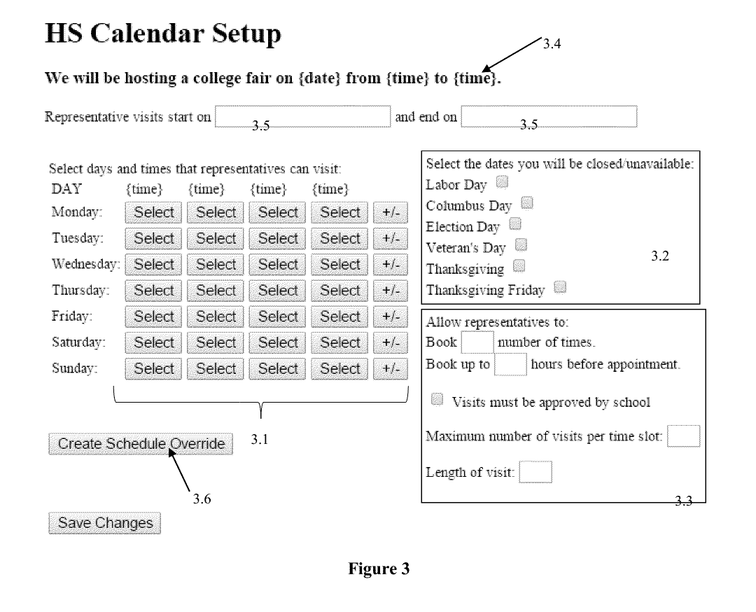

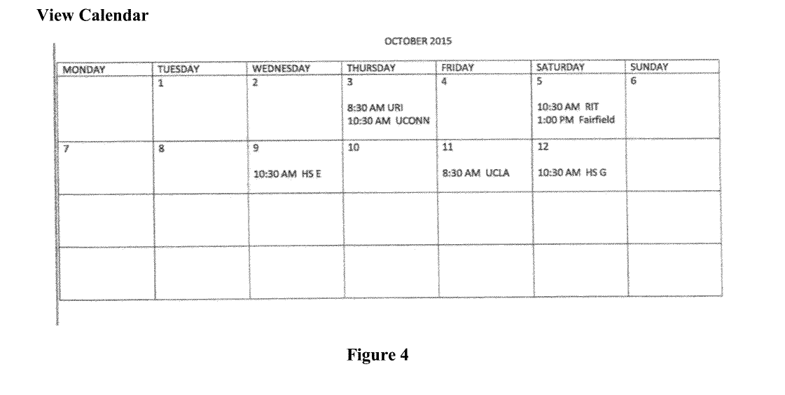

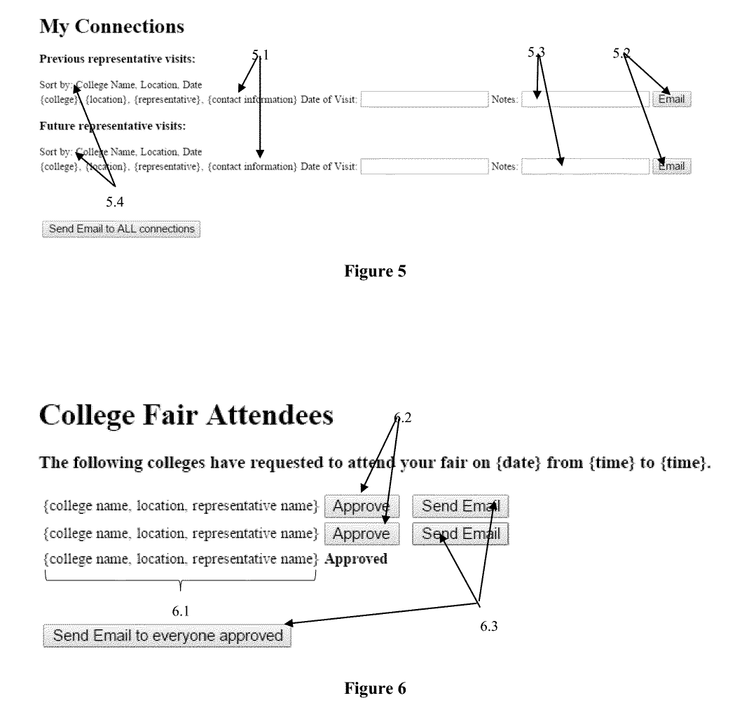

Referring to FIG. 2-FIG. 6, the high school may set up their account by inputting contact information (2.1), school demographics (2.2) and other pertinent information (2.3). They then set up their calendar (FIG. 3) with specific dates and times (3.1), closures (3.2), visit specifications (3.3), college fair dates (3.4), start date and end date in which visits can occur(3.5) and customize a schedule (3.6) for specific date(s) where the high school has a unique schedule (for example but not limited to: parent conferences, advisory, etc). The high school can use the “view calendar” feature (FIG. 4) to view which representatives have booked appointments. The high school can also use the “my connections” feature (FIG. 5) to view contact information (5.1), send emails (5.2) to previous or future appointments, or take notes (5.3). They will also be able to sort their connections by high school name, location or date (5.4). The high school can use the “College Fair Attendees” feature (FIG. 6) to view which post-secondary institutions have made requests (6.1), approve pending requests (6.2), and send individual or group emails (6.3).

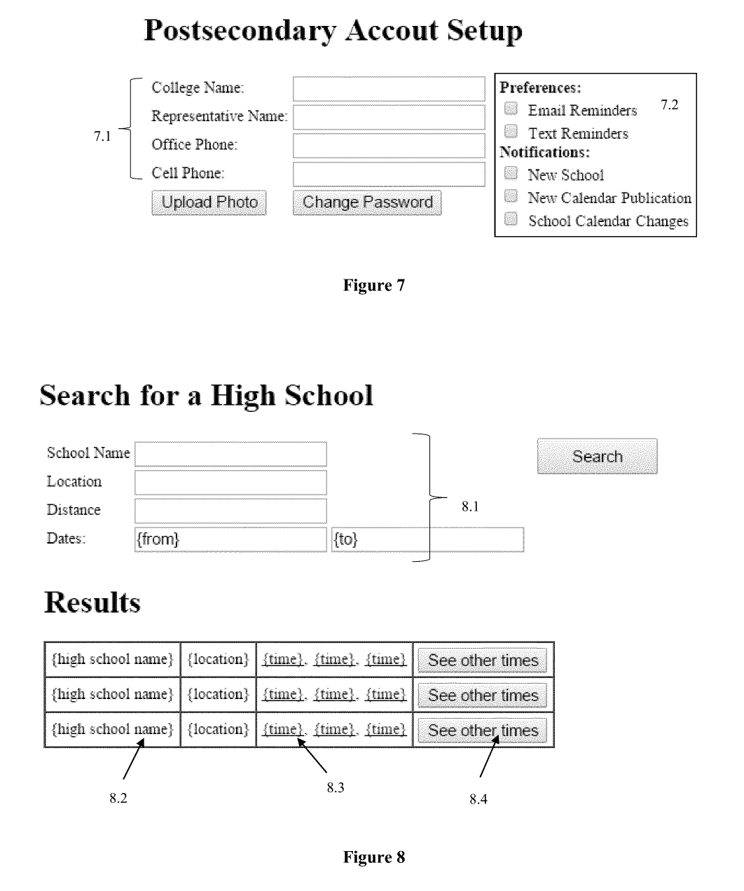

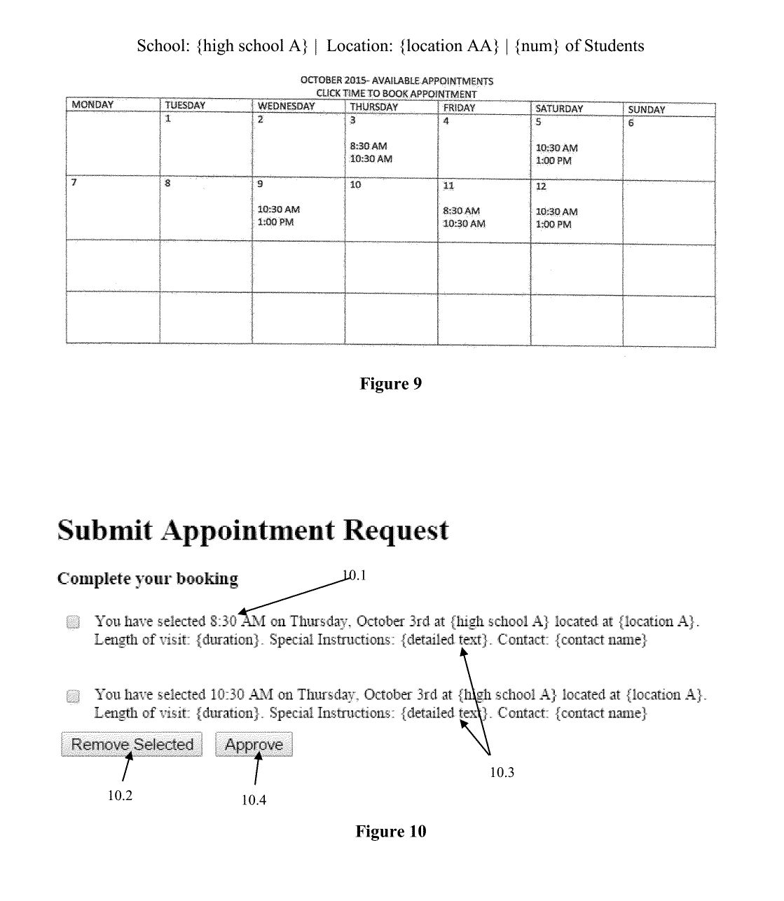

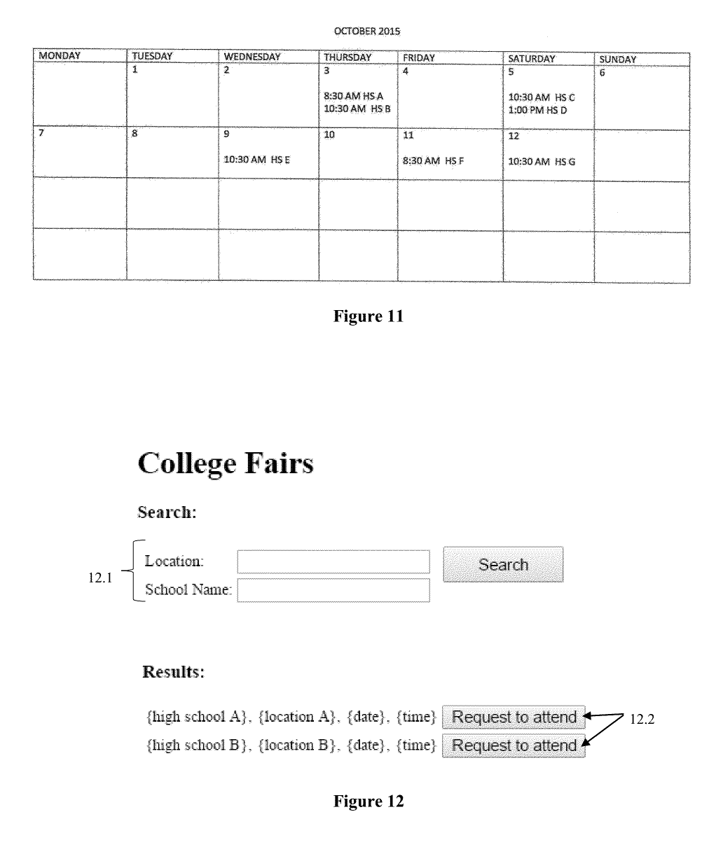

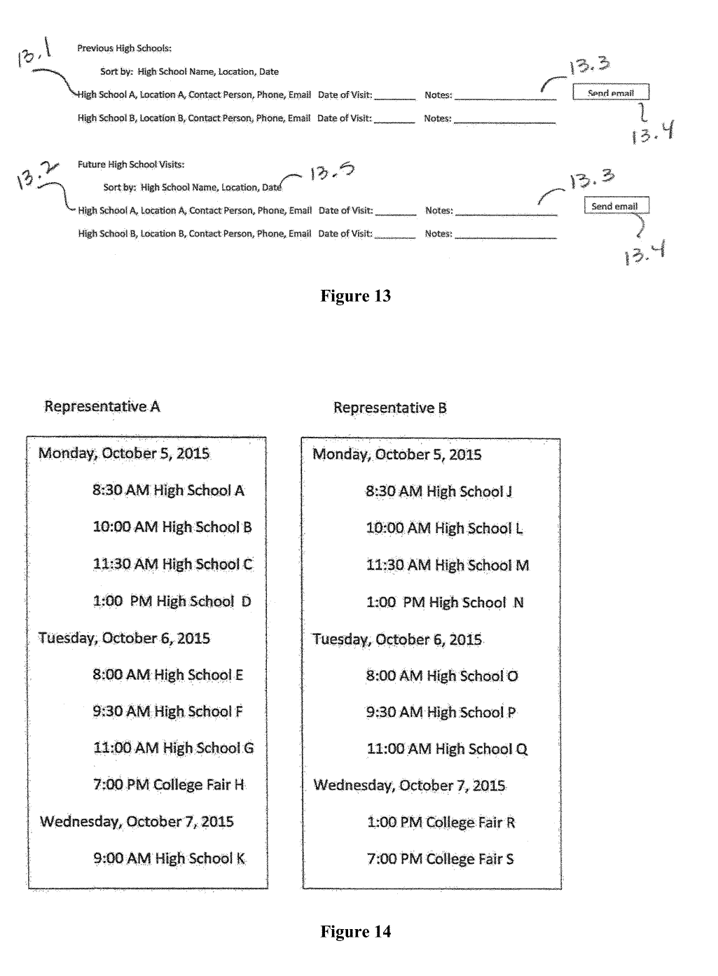

Referring to FIG. 7-FIG. 10, the post-secondary representative may set up an account by inputting contact information (7.1) and notification preferences (7.2). These preference may include options for the user to request notifications of new high schools, newly published calendars, and changes to existing calendars. These notifications may include details of the new or changed information. They would use the high school search tab (FIG. 8) to locate schools by name, location, distance and/or availability (8.1). Under results the post-secondary representative may see the high schools that fit their search criteria (8.2) and then click on an available time to set up visit(s) (8.3). If the representative wanted to see additional dates or times, they can view the high school's full appointment calendar by selecting “view other date/times” (8.4). If “view other dates/times” (8.4) was selected, a full view of that high school's calendar would appear (FIG. 9). After choosing an appointment, as shown in FIG. 8 and/or FIG. 9, a preview of the high school's information and appointment would be displayed (10.1), thus allowing the post-secondary representative a chance to cancel (10.2) or submit the request (10.4), read specific instructions from the high school (10.3). The post-secondary representative may then use a “rep schedule” feature to see their high school appointments (FIG. 11). The post-secondary representatives would use the “College Fairs” feature (FIG. 12) to search for college fairs by location or high school (12.1) and request a reservation for the high school college fairs (12.2). The post-secondary representatives may use the “my high school connections” feature (FIG. 13) to view contact information for previous visits (13.1) or future visits (13.2), take notes (13.3) and send emails (13.4) to connections. They will also be able to sort or search for their connections by high school name, location or date (13.5).

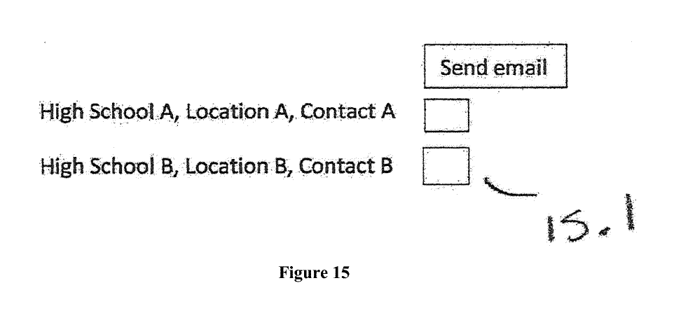

Referring to FIG. 14 and FIG. 15, the post-secondary director may have a master account with access to all representatives' schedules (FIG. 14) and connections (FIG. 15) with the ability to send individual or group emails (for example but not limited to staff changes or surveys regarding the visit) (15.1). Additionally, it is contemplated that in additional embodiments, the post-secondary director may be able to manage and/or modify schedules as desired.

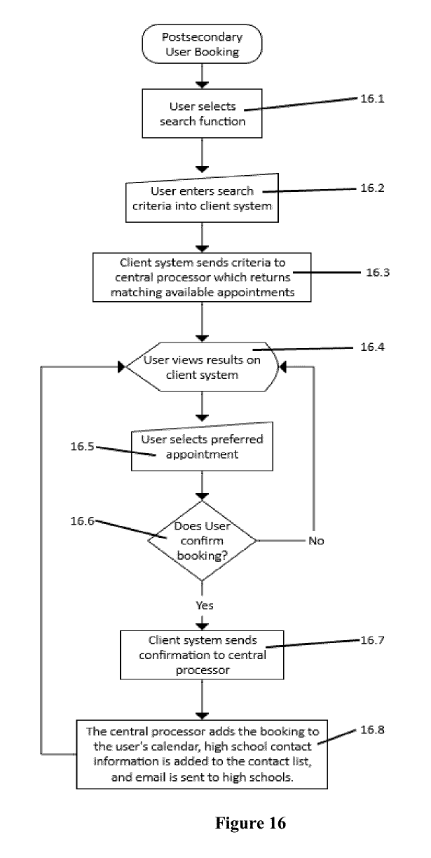

In a second embodiment of the invention, as illustrated by FIG. 16, the post-secondary user may utilize the invention to request a reservation with a high school. Once the user has authenticated with the system and has been authorized for the search function, the user may select the search function from the user interface (16.1). The user may then enter the desired criteria of the high school and appointment (16.2) and submit the criteria to get the desired search results (16.3). The user may view (16.4) the results and choose the available appointments that best suit the user's needs (16.5). Additionally, the user may confirm their choice of appointments (16.6). If the user chooses to not confirm the selected appointment, they may be returned to the results of the search (16.4). If the uses confirms the appointments, the information may be processed (i.e. sent to a central and/or local processor for processing) (16.7) and the appointment may be saved as a reservation and a relationship will be established between the post-secondary user and high school user's accounts permitting access to various account details (16.8).

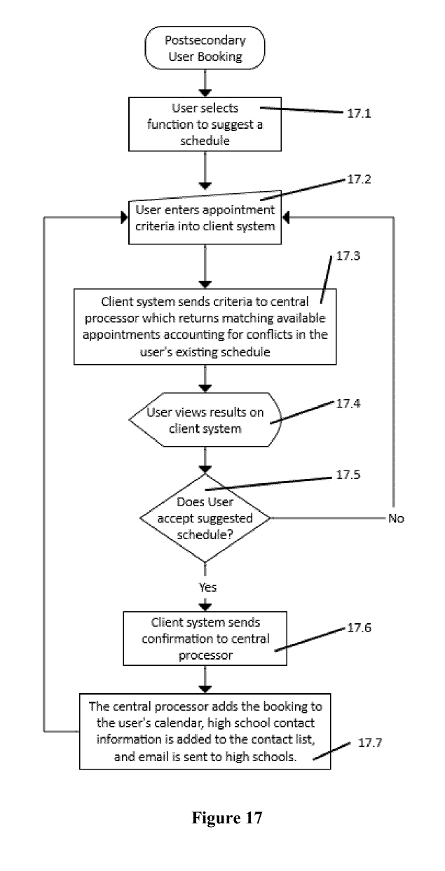

In a third embodiment of the invention, as illustrated by FIG. 17, the post-secondary user may utilize the invention to create multiple reservations through the use of an auto-suggestion feature. Once the user has authenticated with the system and has been authorized for the auto-suggest function, the user may select the auto-suggest function from the user interface (17.1). The user may then enter the criteria (e.g. date, times, location and distance) for the suggested schedule (17.2). The user sends this data to a processing unit which finds matching appointments, taking into consideration the user's existing schedule (17.3). The processing unit processes the data to identify matching appointments and returns the matches for review and acceptance by the user (17.4-17.5). If the user does not accept the suggestions, the user may be returned to the auto-suggest criteria page (17.2). If the user accepts one or more of the suggestions, the information is sent to the processor (17.6) to create the associated reservations and a relationship will be established between the post-secondary user and high school user's accounts permitting access to various account details (17.7).

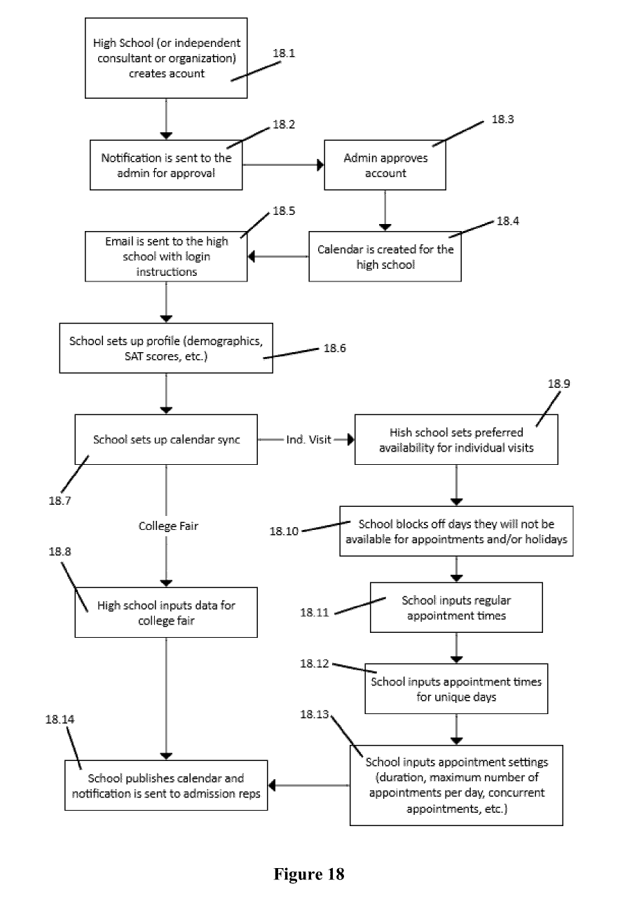

In a fourth embodiment of the invention, as illustrated in FIG. 18, a high school user starts by creating an account (18.1) that is sent to the administrator for approval (18.2). Once the approval is complete (18.3), a calendar may be created for the school (18.4) and the user may be notified via an email (18.5) that contains instructions to gain access to the solution. The high school user may setup a profile (18.6) for the school and establish a calendar (18.7) for representatives to use to book appointments with the school. The high school user may setup a new college fair (18.8) by entering the appropriate details and criteria. Once that information is saved, the school may publish the event on their calendar (18.14). For individual appointments, the school may set up additional criteria (18.9-18.13) and when finished, the user may publish the calendar (18.14).

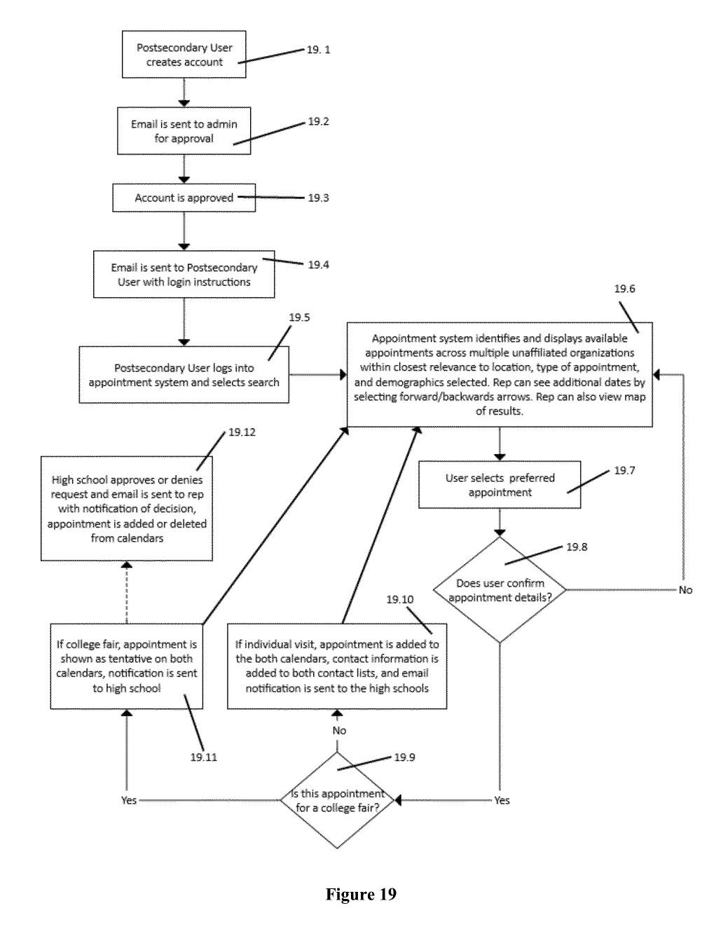

In a fifth embodiment of the invention, as illustrated in FIG. 19, the post-secondary representative may create an account (19.1) that may be sent for approval (in additional embodiments approval may not be required) by the administrator (19.2). Once approved (19.3), the post-secondary user may access the appointment system (19.5) through the details in the approval message (19.4). The user may enter the desired criteria and search for high schools with available appointments (19.6). The system may use some or all the criteria including geographic information to generate results listing available appointments within a geographic range allowing the post-secondary users to optimize their appointments and reducing wasted time traveling. The user may then choose the appropriate appointments (19.7). The user may be presented with an option to approve (19.8) or cancel the appointments. If the appointments are cancelled, the user may be returned to the search form. If the user approves one or more of the appointments, the request may be sent to the school for further processing (19.9-19.12) depending on the type of appointment.

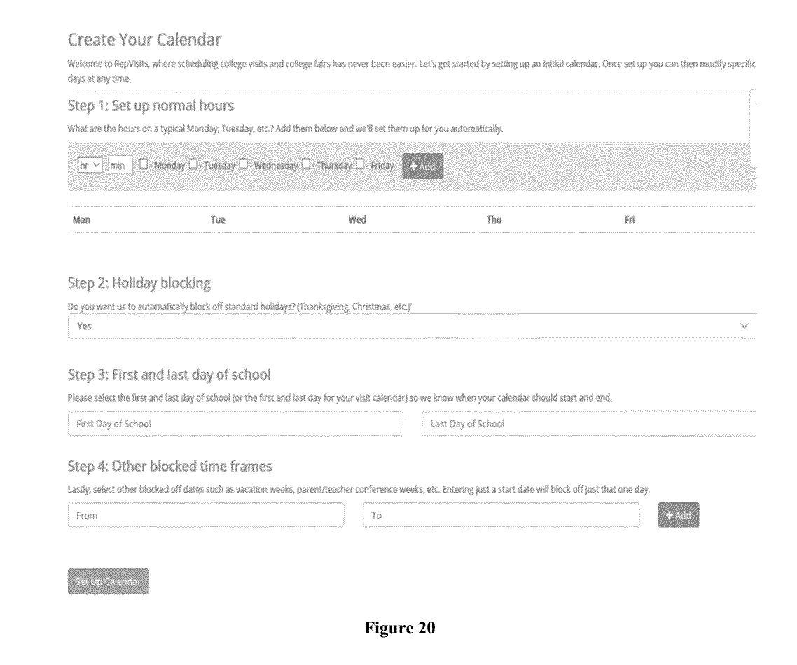

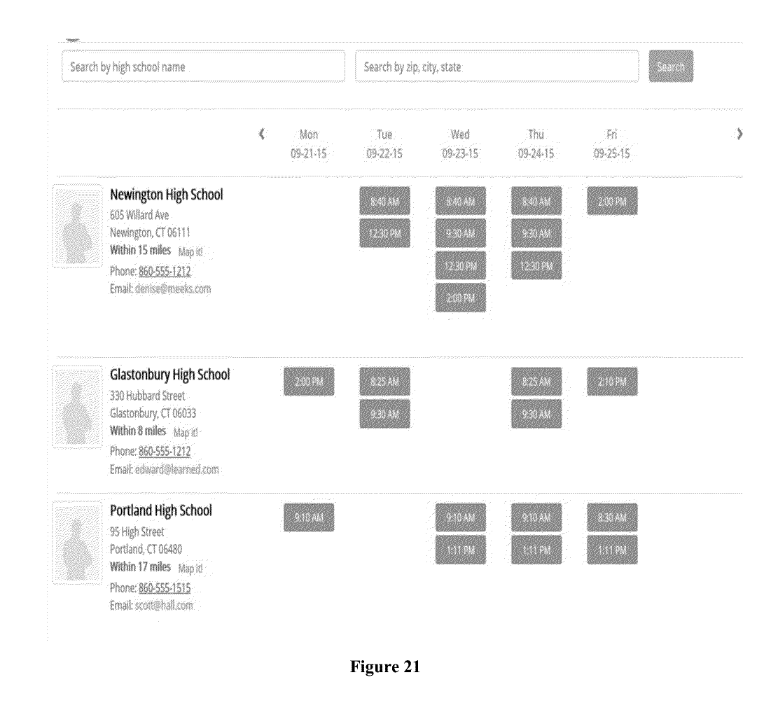

In a sixth embodiment of the invention, as seen in FIG. 20 and FIG. 21, the high school user is able to input various sets of criteria, including first and last day of school, school holidays, and normal appointment hours per week. In FIG. 21, the post-secondary user is able to search for available appointments and send a reservation request through a modified calendar view.

It should be appreciated that an additional feature of the present invention includes an on-line community forum which allows users to post questions and advice regarding visits, such as for example, local amenities (restaurants, wifi spots, hotels, etc.) or additional information on high schools (parking, road closures). Yet another feature includes the ability to establish Information/interview sessions—college reps can set up a calendar for campus information sessions or interviews and allow students to register for appointments. Still yet another feature includes an invite only feature which can be used to limit who can sign college fairs. And still yet another feature includes the ability of the high school to share with the representative, the number of students who have signed up for an appointment prior to the meeting.

It should be appreciated that while the invention is disclosed herein with regards to educational applications, it is contemplated that the invention may be used for applications in other various industries, such as business, finance, medical, etc. Thus, the scope of the invention is not limited to the field of education and the educational market is only for illustrative purposes.

A machine-readable computer program code and/or a medium encoded with a machine-readable computer program code for implementing the method of the invention is provided, wherein the code and/or medium includes instructions for causing a controller to implement the method of the invention. In accordance with an exemplary embodiment, the processing of the present invention may be implemented by a controller disposed internal, external or internally and externally to the Web server. In addition, processing of the present invention may be implemented through a controller operating in response to a computer program. In order to perform the prescribed functions and desired processing, as well as the computations therefore (e.g. execution control algorithm(s), the control processes prescribed herein, and the like), the controller may include, but not be limited to, a processor(s), computer(s), memory, storage, register(s), timing, interrupt(s), communication interface(s), and input/output signal interface(s), as well as combination comprising at least one of the foregoing.

The invention may be embodied in the form of a computer or controller implemented processes. The invention may also be embodied in the form of computer program code containing instructions embodied in tangible media, such as floppy diskettes, CD-ROMs, hard drives, and/or any other computer-readable medium, wherein when the computer program code is loaded into and executed by a computer or controller, the computer or controller becomes an apparatus for practicing the invention. The invention can also be embodied in the form of computer program code, for example, whether stored in a storage medium, loaded into and/or executed by a computer or controller, or transmitted over some transmission medium, such as over electrical wiring or cabling, through fiber optics, or via electromagnetic radiation, wherein when the computer program code is loaded into and executed by a computer or a controller, the computer or controller becomes an apparatus for practicing the invention. When implemented on a general-purpose microprocessor the computer program code segments may configure the microprocessor to create specific logic circuits.

While the invention has been described with reference to an exemplary embodiment, it should be understood by those skilled in the art that various changes may be made and equivalents may be substituted for elements thereof without departing from the scope of the invention. In addition, many modifications may be made to adapt a particular situation or material to the teachings of the invention without departing from the scope thereof. Therefore, it is intended that the invention not be limited to the particular embodiment disclosed as the best mode contemplated for carrying out this invention, but that the invention will include all embodiments falling within the scope of the appended claims. Moreover, unless specifically stated any use of the terms first, second, etc. do not denote any order or importance, but rather the terms first, second, etc. are used to distinguish one element from another.

What is claimed is:

1. A method for scheduling and maintaining appointments between multiple parties, wherein the method is implemented via a processing device, the method comprising:
creating an online account for a first user and setting up a first user calendar wherein the first user calendar is configurable to include first user information and wherein the first user information include a date and time that first user is available for a meeting;
creating an online account for a second user, wherein the second user is configured to be able to view the first user calendar and the first user information; and
allowing the second user to access the first user calendar to modify the first user information to set up a meeting appointment by reserving the date and time for a first meeting.

2. The method of claim 1, further comprising
creating an online account for a third user and setting up a third user calendar wherein the third user calendar is configurable to include third user information and wherein the third user information includes a date and time that the third user is available for a meeting,
wherein the second user is allowed to access the third user calendar to modify the third user information to set up a meeting appointment by reserving the date and time for a second meeting.

3. The method of claim 2,
wherein the first user information includes a first meeting location, first meeting time, and a first meeting duration,
wherein the third user information includes a second meeting location and a second meeting time, and
wherein the method further comprises,
determining the travel time between the first meeting location and the second meeting location,
determining the time difference between the end of the first meeting and the beginning of the second meeting, and
determining whether there is enough time for the second user to travel between the first meeting location and the second meeting location.

4. The method of claim 2, further comprising,
setting up a second user calendar wherein the second user calendar is configurable to include second user information, wherein the second user information includes second user appointment schedule, and
comparing the second user information with at least one of the first meeting and the second meeting to determine if a scheduling conflict exists.
